(19) United States
(12) Patent Application Publication
(10) Pub. No.: US 2015/0350908 A1
(43) Pub. Date: Dec. 3, 2015

(54) Access Device and System for an Electronic Device

(71) Applicant: Lewis DANIELS, George Town (KY)

(72) Inventor: Lewis Daniels, Allier (FR)

(73) Assignee: Knightsbridge Portable Communications SP, George Town, Grand Cayman (KY)

(21) Appl. No.: 14/758,845

(22) PCT Filed: Dec. 16, 2013
(86) PCT No.: PCT/GB2013/053300

§ 371 Date: Jul. 1, 2015

(30) Foreign Application Priority Data
Jan. 2, 2013 (GB) 1300014.6

(51) Int. Cl. H04W 12/06; H04W 12/08; H04W 4/00; H04L 29/06; H04W 4/02; H04W 12/02; H04W 76/02

(52) U.S. Cl. CPC H04W 12/06; H04W 12/02; H04W 12/08; H04W 76/023; H04L 63/0861; H04W 4/021; H04W 4/008

(57) ABSTRACT

The invention provides a computer implemented verification method and corresponding system. An input device is configured to receive user identification information which is transmitted to a first remote device such as a server. The information may be biometric user information. The server verifies whether the user identified by the information is permitted to access a second remote device, which may be a portable computing device such as a tablet computer for example. If the user has been successfully verified, an output is sent from the first remote device to the input device to permit access to the second remote device. Preferably, the input device is paired with the portable computing device so that the input device serves as a key for unlocking the portable device. The input device may also need to be within proximity to the portable device in order for a wireless communication channel to be established. Thus, the invention provides enhanced security for the protecting access to the portable computing device.

### CROSS-REFERENCE TO RELATED APPLICATIONS

This application is the national stage of International Patent Application No. PCT/GB2013/053300 filed on Dec. 16, 2013, and which claims priority to British Patent Application No. GB 1300014.6 filed on Jan. 2, 2013, both of which are hereby incorporated by reference in their entireties as if fully set forth herein.

### BACKGROUND

1. Field

The present invention relates to a method of verifying access to an electronic device, a verification system and increased security of an electronic device, and more particularly but not exclusively, a portable computing device. The invention is particularly suited for use with tablet computers, laptops, mobile telephones etc which are easily transported and which require enhanced security mechanisms due to the sensitive nature of the data and/or applications which are stored thereon.

Improved security for electronic devices is necessary due to the increase in traffic of sensitive information being inputted, stored on or transferred between electronic devices. This increase in traffic and potential vulnerability of sensitive information leads to significant potential reward for illegally accessing such information. This is particularly important in a number of fields, such as when financial information is transferred, or when sensitive information may be provided on a computing device such as, for example, in military applications.

Aspects of the present invention provide increased security for maintaining the privacy of information that is desired to remain private on an electronic device, by monitoring and/or reducing the possibility of an unauthorised access.

2. Related Art

US 2006/0206723 A1 discloses an authentication arrangement suitable for controlling access to a service providing server (e.g. a web server). US 2010/0138908 A1 discloses an arrangement for controlling access to a network resource (e.g. networked printer). Similarly, WO 96/42041 relates to methods for controlling and monitoring access to network servers.

None of these documents relate to controlling access to a portable computing device such as a laptop, tablet computer, PDA, mobile telephone. Moreover, none of these references disclose arrangements wherein the input device is matched or paired with at least one specific input device.

### SUMMARY

According to a first aspect of the present invention there is a computer implemented verification method comprising the steps of:
a) providing an input device configured to receive user identification information;
b) transmitting the user identification information and/or data representative of the identification information to a first remote device configured to verify whether the user identified by the user identification information and/or data representative of the user identification information is permitted to access a second remote device; and
c) providing an output from the first remote device to the input device to permit access to the second remote device in the event of the user identification information being verified.

Access to the second remote device is preferably permitted by enabling access to the second remote device.

Access to the second remote device is preferably permitted only via the input device or a plurality of specified input devices. This provides an additional layer of security not offered by the prior art arrangements.

Preferably, the input device is able to communicate with the first remote device e.g. server independently of the second remote device e.g. laptop or tablet.

Preferably, the input device and the second remote device are distinct i.e. separate devices.

The second remote device is preferably a portable computing device. Such a method of verification of a user is achieved at the first remote device which may be a server and this server can verify whether the individual is authorised. It can be determined whether the user is cleared to access the device. Further controls may be integrated such as prevention of use of the second device at particular times or in particular locations.

There are numerous applications for such an invention. These will be described in detail in the specific description. Such a method however minimises the potential of unauthorised access through the claimed steps where information transmitted is extremely secure.

The second remote device is beneficially a portable computing device. Throughout this document, the term ‘portable computing device’ may be used to refer to any portable device capable of executing instructions and/or processing data. The portable computing device may be handheld during operation e.g. it may be a mobile telephone or a tablet computer. It may be a laptop computer. Other forms of portable device may also fall within the scope of the present invention.

The input device is beneficially configured to receive biometric user information. This is particularly beneficial for a number of reasons. A first reason is that a third party cannot simply watch to learn a specific identification number. Furthermore, identification numbers can accidently be lost or unintentionally provided to a third party.

In any or all embodiments of the invention, the input device may be referred to as a ‘key’ or a ‘smart key’. It may serve as a security device which is required in order to lock or unlock access to the second remote device. Thus, it provides enhanced security in that anyone wishing to access the second device must have access to the input device.

It is beneficial that there are no external data ports in the input device. Thus, the input device may only be configured for wireless communication with other devices. In combination with an input means comprising a biometric arrangement this adds further security in that the input device can be provided with no external data ports and preferably no external ports at all. Charging may be completed by induction charging and the only input may be achieved via a biometric scanner. This provides additional advantages over and above security, as the input device may be waterproof and suitable for use in rugged or hostile environments.

The user input information beneficially is encrypted prior to transmission to the first remote device. This input information comprises data. In one embodiment the user input information is beneficially processed to data representative of the user identification information. This provides an advantage in that user identification information in its inputted form (although beneficially encrypted) will not be transmitted but instead, for example, a token comprising data representative of the identification information is instead transmitted.

The first remote device is beneficially configured to store user identification information and/or data representative of the user identification information as stored information and compare the stored information with transmitted information comprising user identification information or data representative of the identification information from the input device and provides an output verifying the transmitted information in the event of a match between the stored information and transmitted information. An output may be provided if there is no verification. This output may identify that an unauthorised access has been attempted.

No output is beneficially provided in the event of no match between the stored information and the transmitted information. A match can be an exact match, or a match can be deemed acceptable if falling within a range for example. In the event of matching a fingerprint for example, a transmitted image of a fingerprint is unlikely to exactly match the appearance of a stored fingerprint due to dirt, positioning of the finger etc. As such, an acceptable matching range may be appropriate.

The input device beneficially transmits identification information or data representative of the identification information to the first remote device over a wireless network. In one embodiment the input device may communicate via Wi-Fi to an access point and the user identification information or data representative of the identification information may then be transferred or transmitted to the first remote device and beneficially a server.

The output from the first remote device is beneficially provided to the input device, and permits access to the second remote device by enabling formation of a wireless network between the input device and the second remote device.

The input device therefore effectively pairs with the second remote device. This pairing feature may be present in all embodiments of the invention. The terms ‘paired’ and ‘pairing’ are technical terms known in the art. Thus, the input device may be able to recognise the specific remote device with which it is paired. Pairing of the devices may enable them to establish a communications link. Similarly, the second remote device may be able to recognise the specific input device with which it is paired. The pairing of the input device and the second remote device may be accomplished via software and/or hardware. By pairing the two devices, security is enhanced because the second remote device may not be able to communicate with any input device with which it is not paired. The second remote device may be paired with more than one input device. It may be configured to pair with only a predetermined number of input devices. The input device and/or second remote device may not be able to communicate and/or perform specific operations with any device with which it is not paired. During the pairing process, the input device and the second remote device may perform a handshake operation. They may establish a relationship by creating a link key. An authenticated connection, such as an Asynchronous Connection-Less (ACL) link, may be established between the devices for the transmission of data. The connection may be encrypted to enhance security.

This pairing or forming a network between the input device and second remote device allows the input device to effectively open the second remote device for use which may be the laptop or tablet for example. The input device then effectively becomes a key for accessing the second remote device. The formation of a network may be immediate once a verification signal is received to the input device. The wireless network is beneficially formed in the event of a local and/or predetermined proximity between the input device and the second remote device.

Therefore, the input device may be configured to permit communicate with the second remote device only when the two devices are within a predetermined range relative to one another. Preferably, the input device is not able to communicate with the second remote device when it is not within the specified range relative to the second remote device. The range may be an approximate range rather than an absolute range. Thus, the input device may serve as a proximity device.

Access is beneficially permitted to the second remote device by activation of a user input device communication module. Such a communication module may, for example, be a Bluetooth® module or Near Field Communication (NFC) module. This module may effectively be switched on by the receipt of a verification signal thereby effectively pairing with the second remote device thus enabling a user to access the second remote device. The communication module beneficially communicates with the second remote device via short range communication and preferably via a radio wave communication link. This provides an effective proximity control to enable access to the second remote device as even if the communication module is activated, access to the second remote device may still not be permitted due to lack of proximity. The range of proximity may be controlled and is beneficially selectable. Different format communication systems may be utilised. For example, utilising the communication system Bluetooth® to enable access assuming the user input device is within a certain range of the second remote device. This can be controlled and preselected. Utilising NFC results in the proximity requirement being significantly more important in that the user input device must typically be within a much closer distance to the second remote device.

The method beneficially further comprises the step of obtaining second remote device location information and using the location information in determining whether access to the second remote device is permitted. Control of access to the second remote device is therefore beneficially further enabled by limiting access to the second remote device geographically. This can beneficially be controlled by the first remote device. In one embodiment in the event that the user input device communicates over a Wi-Fi network, location information is provided by an IP address. The second remote device beneficially may comprise a location transmitter. This is beneficial as even if a user overcomes the security associated with providing input to the input device which is verified by the first remote device, an extra layer of security means that if the second remote device is outside a predetermined location or area, then access is further prevented.

The identification information and/or data representation of the identification signal is beneficially transmitted by SMS, Email and/or MMS.

The present invention also extends to a verification system comprising:
a) an input device configured to receive user identification information, the input device comprising a first transmitting arrangement for transmitting the user identification information and/or data representative of the user identification; and
b) a first remote device comprising a receiver arrangement for receipt of the user identification information and/or data representative of the user identification information, the first remote device configured to verify whether the user is permitted to access a second remote device, wherein the first remote device comprises a transmitter arrangement for outputting a verification signal to the input device.

The input device and second remote device may be paired. It will be appreciated that if there is no verification no signal may be sent from the first remote device. Alternatively, however, a signal may be supplied identifying negative verification and such information may be logged.

The first remote device could be a server which is remote from the input device but could, still be local, for example, where the input device is provided in an office and the first remote device is the server to the office. Alternatively, the first remote device may be at a completely separate location and may even be in another country for example.

It will be appreciated that user identification information or data representative of the user identification information may be transferred from the input device to the first remote device. Data representative of the user identification information may be transmitted effectively utilising token authentication technology.

The verification system beneficially further includes the second remote device. The second remote device beneficially comprises a portable computing device and beneficially comprises a pc, laptop, tablet or mobile telephone device.

The input device beneficially comprises a microprocessor chip. The input device beneficially also comprises a biometric scanning arrangement. The input device beneficially comprises a communication module such as a modem module, SIM or Wi-Fi component. The input device beneficially further comprises a data encryption processor, beneficially as a feature of the microprocessor.

The input data device beneficially comprises an arrangement for processing the identification information to data representative of the user identification information.

The first remote device beneficially comprises a data storage device arranged to store user identification information and/or data representative of the user identification information as stored information, the first remote device comprising a processor arranged to compare transmitted information comprising user identification information and/or data representative of the identification information received from the first transmitting arrangement of the input device to the stored information and in the event of a match between the stored information and the transmitted information providing an output to the input device from a second transmitting arrangement to permit access to the second remote device.

In one embodiment it will be appreciated that the first remote device may transmit a signal directly to the second remote device, however, in an alternate embodiment the output is transmitted to the input device.

No output is beneficially provided in the event of no match between the stored information and transmitted information.

The input device is beneficially portable and beneficially physically separate from the first and second remote devices.

The input device beneficially includes at least one arrangement for connecting to a wireless network. The input device may include a wireless network interface card (WNIC) such an arrangement may be utilised to connect the input device wirelessly to the first remote device.

The input device beneficially comprises a receiver arrangement configured to receive the verification signal.

The input device beneficially comprises a communication module arranged to form a wireless network with the second remote device on receipt of a verification signal. The communication module is beneficially configured such that the verification signal enables activation of the communication module. The input device therefore effectively pairs to the second remote device. The communication module is beneficially arranged to communicate with a second remote device via short range communication, and preferably via radio wave communication.

The network or pairing between the input devices may be achieved using one or more Bluetooth® or Near Field Communication (NFC) components.

The user identification information or data representative of the user identification information is beneficially transmitted as data.

The present invention also extends to an input device for use in a system of verifying use of an electronic device, the device having an arrangement for receipt of user input information, an arrangement for transmitting the user input information and/or information representative of the user input identification to a remote device, and an arrangement for receipt of a verification signal from the remote device, wherein the input device comprises a communication module configured to form a network with an electronic device upon receipt of a verification signal.

According to a second aspect of the present invention there is a portable access device comprising a computer-based resource configured to monitor for and/or detect a predetermined wireless signal received from a remote electronic device and send a response signal to the remote electronic device upon detection of the predetermined wireless signal to indicate allowable use of the remote electronic device.

Also according to a second aspect of the present invention there is a method of permitting access to an electronic device comprising the steps of providing a portable access device comprising a computer-based resource configured to monitor for and/or detect a predetermined signal received from a remote electronic device and sending a response signal to the remote electronic device upon detection of the predetermined signal to indicate allowable use the remote electronic device.

Such an arrangement provides benefits either alone or combination with the invention described above. A significant benefit is that the electronic device which is beneficially a computing device and beneficially a mobile computing device and even more beneficially a PC, tablet, laptop or mobile telephone, can only function with the provision of the access device which may be equated to a key. The key may be the user input device as defined with respect to the first aspect.

The mobile computing device, preferably when turned on by a user, transmits a search signal in accordance with a predetermined criteria, wherein the access device can send a second signal back to the mobile computing device causing allowance of use of the mobile computing device. Without the predetermined criteria being met, access to the mobile computing device is not enabled.

In combination with the first aspect of the invention, the search signal transmitted from the mobile computing device (second device as defined above) may be transmitted at periodic intervals, and in the event of the communication module in the user input device being activated then a network can be formed thereby allowing access to the electronic device.

The second signal beneficially enables access to the device in the event of the second signal satisfying predetermined criteria.

The access device and the electronic device are preferably physically separated. The predetermined criteria beneficially may include one or more of a predetermined identifier, a predetermined data type, a predetermined signal frequency, a predetermined encryption type.

Aspects of the present invention will now be described by way of example only with reference to the accompanying drawings.

### BRIEF DESCRIPTION OF THE DRAWINGS

FIG. 1 is a schematic system according to and incorporating exemplary embodiments of the present invention.

FIG. 2 is a schematic alternative system according to one or more exemplary embodiments of the present invention.

FIG. 3 is a schematic diagram of an exemplary embodiment of a second aspect of the present invention.

### DETAILED DESCRIPTION

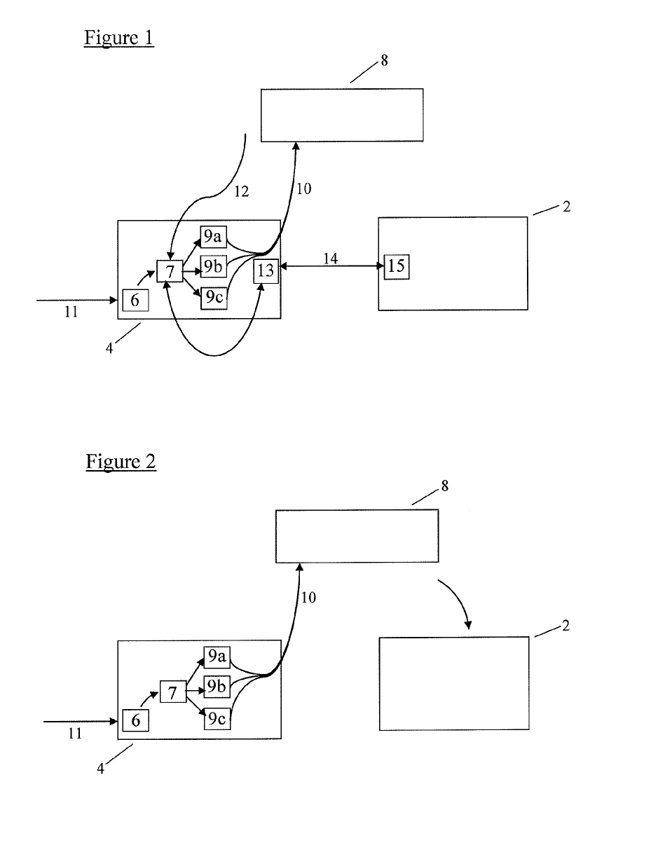

Referring to FIG. 1 there is a schematic diagram of an aspect of the present invention and incorporating aspects of the present invention. Reference will be made through the exemplary embodiments to a portable computing device (2) which may be, for example, a tablet, personal computer, mobile telephone or other. This system beneficially also comprises a smart key (4) which includes a user input arrangement (6) that beneficially comprises a biometric scanner. The smart key (4) is arranged to be portable and unobtrusive for carrying by a person. Such a smart key (4) may therefore be kept in a user's pocket. The system also includes a remote device (8) which is beneficially a remote server. The term remote means that it is not physically connected to the smart key (4) and as such the remote device (8) may, for example, be located in the same building as the building in which the user wants to use the device (2) or alternatively may be located in a location anywhere in the world. The smart key (4) beneficially comprises a microprocessor chip, beneficially a ‘Maxim’ or similar secure processor (T) and transmitter and receiver arrangements. The smart key (4) beneficially also comprises an encryption processor to encrypt any data or information transmitted from the smart card (4) and received at the smart card (4), which is achieved also by the ‘Maxim’ chip. The smart key (4) may also comprise a modem module. In addition, a Wi-Fi component and/or preferably Bluetooth® or Near Field Communication (NFC) components are provided.

The smart key (4) is provided to provide a layer of security when a user wishes to access the device (2). In one, some or all embodiments, the smart key (4) may be paired with the device (2) so that access to the device (2) is only possible via the paired smart key (4). This further enhances security.

In use, the embodiment as described in FIG. 1 starts with a user inputting identification information into the user input arrangement (6). This is beneficially biometric information such as a fingerprint but it will be appreciated that a numerical input may be provided. The provision of biometric information such as a fingerprint into the user input arrangement (6) provides increased security however. The information which may, for example, be an image of the inputting person's fingerprint or data representative of the image, for example, may be encrypted by the encryption processor (7) (i.e. the ‘Maxim’ chip). This information or data is transmitted to the remote device (8) via a number of alternative modules (9a-c) via alternative routes such as MMS in the event of an image, a Wi-Fi module (9a), 3G/4G module (9b), SIM card (9c) and as such, may be emailed to the remote device (8). This is indicated by arrow (10). In any event, the data transmitted has been encrypted by the processor (7). The user input is identified by reference numeral (11). As will be appreciated, the smart key (4) may connect to the remote device (8) by a number of alternative means identified by reference numerals (9a-9c), however, as communication standards change alternatives will be considered appropriate.

The location of the smart key (4) is known due to the IP address associated with Wi-Fi connection that has been made and as such the location can be confirmed and deemed whether appropriate for use of the device. If appropriate, user verification is overridden to prevent use of the device in an unauthorised location. It will also be appreciated in alternative embodiments that the smart key (4) location may be determined when using a SIM card or using a 3G/4G network the location can be determined by GSM.

Data or information is then transmitted from the smart key (4) to the remote location (8). This information as previously described may be an image, it may be data representative of an image, it may solely be data or it may be a token which is derived from the user input information. Use of a token means that no actual user input information is transmitted thereby improving security further. In any event, the information and/or data is encrypted by the processor (7). This signal, having been encrypted, is secure meaning unauthorised access to the encrypted data is extremely difficult.

The remote location (8) comprises an arrangement to compare the information or data received from the smart key (4) with known user identification information. If there is matching between the stored data or information and the received data or information, then a signal is arranged to be transmitted from the remote location (8) to the smart key (4). In the event there is no matching then in one embodiment no signal is transmitted thus meaning that there is no access enabled to the second remote device. Alternatively, the signal may contain information confirming identification of the user or may transmit a signal containing information that the user is not recognised. Incorrect user information may be stored at remote device (8) or alternatively on the smart key (4). The smart key (4) may comprise means to inform a user that incorrect identification information has been inputted.

In the event that positive identification is achieved then signal (12) is transmitted to the smart key (4). The signal (12) is a verification signal of the user input information. The signal is beneficially different to the signal transmitted to the remote location (e.g. server) (8) and again is beneficially encrypted. The processor (7) decrypts the signal (12). The processor (7) will then in one embodiment enable or turn on an input device communication module (13) enabling wireless connectivity with the device (2). This turning on of a Bluetooth or NFC communication module for example may in itself be sufficient to allow access to the device (2), as turning on of the NFC or Bluetooth of the smart key (4) may result in a signal being transmitted (14) containing predetermined information for receipt by a communication module (15) of the device (2) to allow access to the device (2). A user will then be allowed to use the device (2) as they would normally. If, for example, the device (2) is not used for a predetermined period of time, or alternatively, is switched off or locked by a user, the user may then be required to repeat the process to again enable access to the device (2).

In an alternative configuration, the device (2) comprises a communication module such as a Bluetooth® or NFC communication module (15) arranged to transmit a search signal continuously or at time intervals. If the user input device (4) is within communication range and is turned on due to the verification signal from the remote device (8), then pairing or matching can automatically occur and access to the device (2) can be enabled.

Such an arrangement or system provides significant benefits over the prior art in that the device (2) cannot be accessed without user identification which has been checked and verified at a remote device prior to enabling access whilst requires proximity of the input device (4) and the device (2) in order to form a communication network therebetween thus allowing access to the device (2). Furthermore, the device (2) cannot be accessed if out of range of the user input device (2), as a communication network cannot be formed due to the separation. Radio frequency communication means such as Bluetooth® are therefore beneficial as the separation between input device or smart key (4) and device (2) can determine whether access to device (2) is enabled. The activation distance can be set according to particular requirements.

A smart key (4) or user input device (4) is therefore beneficially further acting as a proximity device meaning that access to the device (2) can only be enabled under a first condition of positive user verification from a remote server (8) and subsequently can only be used when in a predetermined range of the device (2). If unauthorised access was attempted an unauthorised user would need to firstly overcome the verification aspect and would then need to have the smart key (4) in proximity to the device (2). To intercept a signal transmitted between the smart key (4) and the device (2) it would be necessary to be in the range between the smart key (4) and the device (2) and to intercept the signal which would be transmitted on a unique channel. It will be appreciated that the distance between the smart key (4) and the device (2) can be set such that access is only enabled within a predefined range.

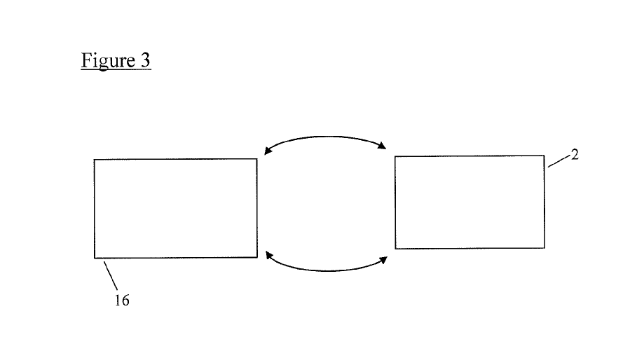

Referring to FIG. 2, there is an alternative less secure embodiment where like components have been identified with the same reference numeral. In this embodiment the remote location (8) instead of transmitting a signal containing data or information confirming verification of the user back to the smart key (4) instead delivers a signal which is beneficially encrypted directly to the device to which then decrypts this information or data. As shown in FIG. 2, in such an embodiment there is no direct communication between the smart key (4) and the device (2). Such an embodiment does, however, have reduced security in comparison to the embodiment of FIG. 1 and the embodiment as described below in FIG. 3.

Using a system as hereinbefore described provides a further advantage in that duress code may be input to the smart key which could be, for example, programmed at the remote device (8) to be an alternative fingerprint, for example, or a different input code. This provides information to the remote location (8) that the user inputting information was under duress and appropriate action could be taken. This may, for example, include providing a signal from the remote server (8) to the smart key (4) to cause a signal to be transmitted to the device (2) to cause locking of the device (2) or clearing of the memory of the device (2).

As described above, this invention provides significant control of the use of a device such as portable computer. The encrypted data sent to the first remote device (8) (server) identifies the location of the smart key (4), which may be achieved through the IP address or GSM information. The time of access is identified as is the person using the device. By using biometric information to identify the user, a password cannot simply be provided to a third party. In the event, for example, it is not desirable for the user identified to use the device in that location or at that time, then this can be prevented by transferral a verification signal or informing the user that they are not authorised.

There are a large number of applications for such an invention. A first example may, for example, be in a city trading environment, where an individual user's computing device can be protected from unauthorised access. For example, if the user is seated at their station in front of their device then they authorise themselves to use the device through inputting their unique identification details such as their biometric information from their finger which is verified at the server in the office which then turns on a communication module in the smart key thus enabling access to the computer. As wireless signals are transmitted access is enabled effectively immediately. However, when a user leaves the room the computer that they are using is protected from unauthorised access. In this case the smart key may be out of range of the computer thus breaking the network connection between the smart key and the computer. As such, access to the computer is prevented. This means, for example, in trading situation that a trade could not be placed by an unauthorised person. The provision of the system also provides a history of when the authorised user had access to their computer and also where they accessed their computer in the event that their computer is of a portable nature.

Another use of the present invention could be in transport systems such as for authorised use of a vehicle. The smart key could be the key to the vehicle. When a user inputs their unique identification information this is confirmed to a remote control location which may, for example, be an insurance company or traffic control system. If the user was authorised and verification is provided to the smart key which then enables a network to be formed with the vehicle thus enabling access to the vehicle. The remote server then knows who, when and where the vehicle is being used. This information could be used to identify the user of a vehicle at a particular time, for example, if there was an accident. It may further be used by an insurance company to determine the usage of a vehicle. The system also prevents unauthorised access to the vehicle by an unauthorised user.

A further example for the use of such a system may be a temporary camp that may be set up, for example, by an army in a foreign territory. A server may be set up by the Commanding Officer which is Wi-Fi enabled. It is possible that a single computing device may be used by a number of different people whereby each user has their own smart key. In such an example, access to files on the computer may be controlled depending on the user. For example, a first user may be authorised to use the computing device but only have access to the network at certain times, and may only access certain files. This can be controlled and recorded. Other personnel may have greater access in more locations, for a longer time, or may be allowed to access secure files. This can be controlled by the present invention.

It will be appreciated that the device (2) is beneficially a portable computing device. It is also beneficial that the computing device (2) does not require any external data ports and preferably does not require any external ports at all. Furthermore, the smart key (4) beneficially comprises no external ports. Charging of the smart key (4) may be achieved by induction charging. This adds to the security of the device (2) as it further reduces possibility of unauthorised access.

Referring now to the apparatus of FIG. 3, such an apparatus comprises a device (2) as previously described and an access device (16). The access device is configured to, for example, fit in a person's pocket. The proximity device is configured such that it enables access to the device (2) under certain circumstances. An example of a suitable use for such a proximity device is in an office where the device (2) will only work assuming that the user who has the access device is within certain proximity. For example, when they leave the room the separation might be too great for connection between the access device and the device (2) and the device automatically configured to be locked.

In one or more embodiments the device (2) comprises a transmitter for transmitting a search signal for the proximity device. The device is beneficially matched (paired) to a specific proximity device or more than one proximity device. As such, when the proximity device (16) comes into range of the signal, the signal is received and verified to ensure that the signal comprises information or data that is expected. In the event of the correct information or data being provided, the proximity device (16) comprises a transmitter for transmitting a return signal to the device (2) confirming that access to the device (2) is allowable.

It should be noted that the above-mentioned embodiments illustrate rather than limit the invention, and that those skilled in the art will be capable of designing many alternative embodiments without departing from the scope of the invention as defined by the appended claims. In the claims, any reference signs placed in parentheses shall not be construed as limiting the claims. The word “comprising” and “comprises”, and the like, does not exclude the presence of elements or steps other than those listed in any claim or the specification as a whole. In the present specification, “comprises” means “includes or consists of” and “comprising” means “including or consisting of”. The singular reference of an element does not exclude the plural reference of such elements and vice-versa. The invention may be implemented by means of hardware comprising several distinct elements, and by means of a suitably programmed computer. In a device claim enumerating several means, several of these means may be embodied by one and the same item of hardware. The mere fact that certain measures are recited in mutually different dependent claims does not indicate that a combination of these measures cannot be used to advantage.

1. A computer implemented verification method comprising the steps of:
a) providing an input device configured to receive user identification information;
b) transmitting the user identification information and/or data representative of the user identification information to a first remote device configured to verify whether the user identified by the user identification information and/or data representative of the user identification information is permitted to access a second remote device; and
c) providing an output from the first remote device to the input device to permit access to the second remote device in the event of the user identification information being verified.

2. The computer implemented verification method according to claim 1, wherein the input device and the second remote device are paired.

3. The computer implemented verification method according to claim 1, wherein the second remote device is a portable computing device.

4. The computer implemented verification method according to claim 1, wherein the input device is configured to receive biometric user information.

5. The computer implemented verification method according to claim 1, wherein the user input information is encrypted prior to transmission to the first remote device.

6. The computer implemented verification method according to claim 1, wherein the user input information is processed to data representative of the user identification information.

7. The computer implemented verification method according to claim 1, wherein the first remote device is configured to store user identification information and/or data representative of the user identification information as stored information and compare the stored information with transmitted information comprising user identification information and/or or data representative of the identification information from the input device and providing an output verifying the transmitted information in the event of a match between the stored information and transmitted information.

8. The computer implemented verification method according to claim 7, wherein no output is provided in the event of no match between the stored information and transmitted information.

9. The computer implemented verification method according to claim 1, wherein the input device transmits identification information and/or data representative of the identification information to the first remote device over a wireless network.

10. The computer implemented verification method according to claim 1, wherein the output from the first remote device is provided to the input device, and permits access to the second remote device by enabling formation of a wireless network between the input device and the second remote device.

11. The computer implemented verification method according to claim 10, wherein the wireless network is formed in the event of at least one of local and predetermined proximity between the input device and the second remote device.

12. The computer implemented verification method according to claim 1, wherein the output from the first remote device to the input device causes activation of an input device communication module to enable access to the second remote device, wherein the communication range whereby communication is enabled between the user input device and the second remote device is controllable and adjustable.

13. The computer implemented verification method according to according to claim 12, wherein the communication module communicates with the second remote device via short-range communication including a radio wave link.

14. The computer implemented verification method according to claim 1, wherein the method further comprises the step of obtaining second remote device location information and using the location information in determining whether access to the second remote device is permitted.

15. The computer implemented verification method according to claim 1, wherein the identification information and/or data representative of the identification signal is transmitted by at least one of SMS and email SMS.

16. A verification system comprising:
a) an input device configured to receive user identification information, the input device comprising a first transmitting arrangement for transmitting the user identification information and/or data representative of the user identification; and
b) a first remote device comprising a receiver arrangement for receipt of the user identification information and/or data representative of the user identification information, the first remote device configured to verify whether the user is permitted to access a second remote device, wherein the first remote device comprises a transmitter arrangement for outputting a verification signal to the input device.

17. The verification system according to claim 16, including further comprising a second remote device.

18. The verification system according to claim 17, wherein the input device and the second remote device are paired.

19. The verification system according to claims 16, wherein the second remote device comprises a portable computing device.

20. The verification system according to claim 16, wherein the input device includes a biometric scanning arrangement.

21. The verification system according to claim 16, wherein the input device comprises a modem module, and a data encryption processor.

22. The verification system according to claim 16, wherein the input device comprises an arrangement for processing identification information to data representative of the user identification information.

23. The verification system according to claim 16, wherein the first remote device comprises a data storage device arranged to store user identification information and/or data representative of the user identification information as stored information, the first remote device comprising a processor arranged to compare transmitted information comprising user identification information and/or data representative of the identification information received from the first transmitting arrangement of the input device to the stored information and in the event of a match between the stored information and transmitted information providing an output to the input device from a second transmitting arrangement to permit access to the second remote device.

24. The verification system according to claim 16, wherein no output is provided in the event of no match between the stored information and transmitted information.

25. The verification system according to claim 16, wherein the input device is portable and physically separate from the first and second remote devices.

26. The verification system according to claim 16, wherein the input device includes at least one arrangement for connecting to a wireless network.

27. The verification system according to claim 26, wherein input device includes a wireless network interface card (WNIC).

28. The verification system according to claim 16, wherein the input device comprises a receiver arrangement configured to receive the verification signal.

29. The verification system according to claim 16, wherein the input device comprises a communication module to form a network with a second remote device on receipt of a verification signal.

30. The verification system according to claim 16, wherein the input device comprises an arrangement for the formation of a wireless network between the input device and a second remote device.

31. The verification system according to claim 30, wherein the arrangement for formation of a wireless network with a second device comprises a communication module configured such that the verification signal enables activation of the communication module.

32. The verification system according to claim 31, wherein the communication module is arranged to communicate with a second remote device via short range communication, including radio wave communication.

33. The verification system according to claim 29, wherein the communication module comprises one or more of Bluetooth® or Near Field Communication (NFC) components.

34. The verification system according to claim 16, wherein the input device comprises no external ports.

35. An input device for use in a system of verifying use of an electronic device, the device having an arrangement for receipt of user input information, an arrangement for transmitting the user input information and/or information representative of the user input identification to a remote device, and an arrangement for receipt of a verification signal from the remote device, wherein the input device comprises a communication module configured to form a wireless network with an electronic device upon receipt of a verification signal.

36. The input device according to claim 35, wherein the input device is paired with the electronic device.

37. A method of permitting access to an electronic device comprising:
providing a portable access device comprising a computer-based resource configured to monitor for and/or detect a predetermined wireless signal received from an electronic device; and
sending a wireless response signal to the electronic device upon detection of the predetermined signal to indicate allowable use of the electronic device.

38. The method according to claim 37, wherein the electronic device is paired with the portable access device.

39. The method according to claim 37, wherein the portable access device is arranged such that on receipt of the predetermined signal in accordance with predetermined criteria, the portable access device transmits a second signal to the electronic device such that access to the electronic device is permitted.

40. The method according to claim 37, wherein the second signal enables access to the device in the event of the second signal satisfying predetermined criteria.

41. The method according to claim 37, wherein the portable access device and the electronic device are physically separated.

42. The method according to claim 34, wherein the predetermined criteria may include one or more of a predetermined identifier, a predetermined data type, a predetermined signal frequency, or a predetermined encryption type.

43. A portable access device comprising:
a computer-based resource configured to
monitor for and/or detect a predetermined wireless signal received from a remote electronic device, and
send a response signal to the remote electronic device upon detection of the predetermined wireless signal to indicate allowable use of the remote electronic device.
